(19) United States
(12) Patent Application Publication
(10) Pub. No.: US 2016/0081056 A1
(43) Pub. Date: Mar. 17, 2016

(54) SYSTEMS AND METHODS FOR ADJUSTING CLEAR CHANNEL ASSESSMENT LEVELS TO INCREASE WIRELESS COMMUNICATION NETWORK THROUGHPUT

(71) Applicant: QUALCOMM Incorporated, San Diego, CA (US)

(72) Inventors: Gwendolyn Denise Barriac, Encinitas, CA (US); George Cherian, San Diego, CA (US); Simone Merlin, San Diego, CA (US); Yan Zhou, San Diego, CA (US)

(21) Appl. No.: 14/852,395

(22) Filed: Sep. 11, 2015

Related U.S. Application Data
(60) Provisional application No. 62/050,681, filed on Sep. 15, 2014.

(51) Int. Cl. H04W 64/00; H04L 12/26

(52) U.S. Cl. CPC H04W 64/006; H04L 43/0882

(57) ABSTRACT

Methods and apparatus for adjusting clear channel assessment levels are disclosed herein. One aspect of the present disclosure provides a method of adjusting deferral on a first wireless communication network. The method includes determining a first distance between the first wireless communication network and a second wireless communication networks operating on a shared or partially-shared channel, determining an adjustment to a deferral mechanism based at least in part on the first distance, and transmitting an indication to one or more stations in the first wireless communication network, the indication based at least in part on the adjustment to the deferral mechanism.

### CROSS REFERENCE TO PRIORITY APPLICATION

This application claims priority under 35 U.S.C. §119(e) to U.S. Provisional Patent Application 62/050,681 entitled “SYSTEMS AND METHODS FOR ADJUSTING CLEAR CHANNEL ASSESSMENT LEVELS TO INCREASE WIRELESS COMMUNICATION NETWORK THROUGHPUT” filed on Sep. 15, 2014, the disclosure of which is hereby incorporated by reference in its entirety.

### FIELD

Certain aspects of the present disclosure generally relate to wireless communications, and more particularly, to methods and apparatus for adjusting clear channel assessment levels to increase wireless communication network throughput.

### BACKGROUND

In many telecommunication systems, communications networks are used to exchange messages among several interacting spatially-separated devices. Networks can be classified according to geographic scope, which could be, for example, a metropolitan area, a local area, or a personal area. Such networks can be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network can transmit/receive information between each other. Device transmissions can interfere with each other, and certain transmissions can selectively block other transmissions. Where many devices share a communication network, congestion and inefficient link usage can result. As such, systems, methods, and non-transitory computer-readable media are needed for improving communication efficiency in wireless networks.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the present disclosure provides a method of communicating in a first wireless communication network. The method includes determining a first distance between the first wireless communication network and a second wireless communication network operating on a shared or partially-shared channel. The method further includes determining an adjustment to a deferral mechanism based at least in part on the first distance. The method further includes transmitting an indication to one or more stations in the first wireless communication network, the indication based at least in part on the adjustment to the deferral mechanism.

Another aspect of the present disclosure provides an apparatus for communicating in a first wireless communication network. The apparatus comprises a processor configured to determine a first distance between the first wireless communication network and a second wireless communication network operating on a shared or partially-shared channel. The processor is further configured to determine an adjustment to a deferral mechanism based at least in part on the first distance. The apparatus further comprises a transmitter configured to transmit an indication to one or more stations in the first wireless communication network, the indication based at least in part on the adjustment to the deferral mechanism.

Yet another aspect of the present disclosure provides an apparatus for communicating in a first wireless communication network. The apparatus includes means for determining a first distance between the first wireless communication network and a second wireless communication network operating on a shared or partially-shared channel. The apparatus further includes means for determining an adjustment to a deferral mechanism based at least in part on the first distance. The apparatus also includes means for transmitting an indication to one or more stations in the first wireless communication network, the indication based at least in part on the adjustment to the deferral mechanism.

In yet another aspect, a non-transitory computer-readable medium comprising code is described that, when executed performs a method of communicating in a first wireless communication network. The method comprises determining a first distance between the first wireless communication network and a second wireless communication network operating on a shared or partially-shared channel. The method further comprises determining an adjustment to a deferral mechanism based at least in part on the first distance. The method further comprises transmitting an indication to one or more stations in the first wireless communication network, the indication based at least in part on the adjustment to the deferral mechanism.

### BRIEF DESCRIPTION OF THE DRAWINGS

FIG. 1 illustrates an example of a wireless communication system in which aspects of the present disclosure can be employed.

FIG. 2 illustrates various components that can be utilized in a wireless device that can be employed within the wireless communication system of FIG. 1, in accordance with an embodiment.

FIG. 3 is an exemplary illustration of two access points and the associated devices in each basic service set, in accordance with an embodiment.

FIG. 4 is an illustration of a method of adjusting deferral rules of a BSS based on BSS distance, in accordance with an embodiment.

FIG. 5 is an exemplary method of communicating in a wireless communication network, in accordance with an embodiment.

### DETAILED DESCRIPTION

Various aspects of the novel systems, apparatuses, and methods are described more fully hereinafter with reference to the accompanying drawings. The teachings disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein it will be appreciated that the scope of the disclosure is intended to cover any aspect of the novel systems, apparatuses, and methods disclosed herein, whether implemented independently of or combined with any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to, or other than, the various aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof

Wireless network technologies can include various types of wireless local area networks (WLANs). A WLAN can be used to interconnect nearby devices together, employing widely used networking protocols. The various aspects described herein can apply to any communication standard, such as Wi-Fi or, more generally, any member of the IEEE 802.11 family of wireless protocols.

In some aspects, wireless signals can be transmitted according to a high-efficiency 802.11 protocol using orthogonal frequency-division multiplexing (OFDM), direct-sequence spread spectrum (DSSS) communications, a combination of OFDM and DSSS communications, or other schemes such as multiple-input and multiple-output (MIMO).

In some implementations, a WLAN includes various devices that access the wireless network. For example, there can be two types of devices: access points (“APs”) and clients (also referred to as stations, or “STAs”). In general, an AP serves as a hub or base station for the WLAN and an STA serves as a user of the WLAN. For example, a STA can be a laptop computer, a personal digital assistant (PDA), a mobile phone, etc. In some aspects, an STA connects to an AP via a Wi-Fi (e.g., IEEE 802.11 protocol such as 802.11ax) compliant wireless link to obtain general connectivity to the Internet or to other wide area networks (WAN). In some implementations an STA can also be used as an AP.

The techniques described herein can be used for various broadband wireless communication systems, including communication systems that are based on an orthogonal multiplexing scheme, such as Orthogonal Frequency Division Multiple Access (OFDMA). An OFDMA system utilizes orthogonal frequency division multiplexing (OFDM), which is a modulation technique that partitions the overall system bandwidth into multiple orthogonal sub-carriers. These sub-carriers can also be called tones, bins, etc.

The teachings herein can be incorporated into (e.g., implemented within or performed by) a variety of wired or wireless apparatuses (e.g., nodes). In some aspects, a wireless node implemented in accordance with the teachings herein can comprise an access point or an access terminal.

An access point (“AP”) can comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ES S”), Radio Base Station (“RBS”), or some other terminology.

A station (“STA”) can also comprise, be implemented as, or known as a user terminal, an access terminal (“AT”), a subscriber station, a subscriber unit, a mobile station, a remote station, a remote terminal, a user agent, a user device, user equipment, or some other terminology. In some implementations an access terminal can comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein can be incorporated into a phone (e.g., a cellular phone or smart phone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

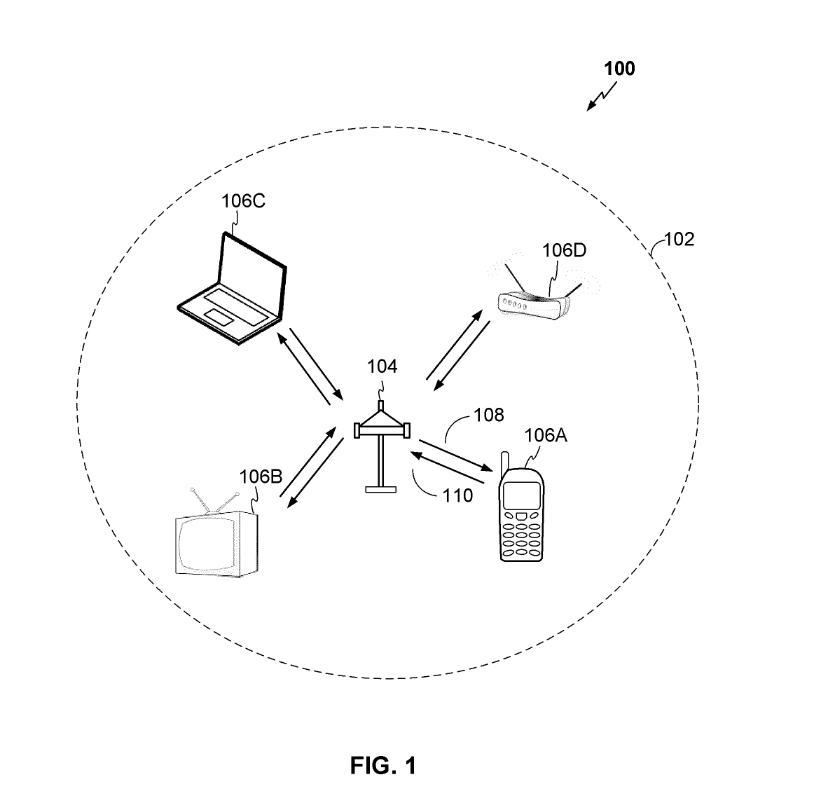

FIG. 1 illustrates an example of a wireless communication system 100 in which aspects of the present disclosure can be employed. The wireless communication system 100 can operate pursuant to an IEEE 802.11 wireless standard such as, for example, the 802.11ax standard. The wireless communication system 100 can include an AP 104, which communicates with STAs 106A-D (referred to herein as “STA 106” or “STAs 106”).

A variety of processes and methods can be used for transmissions in the wireless communication system 100 between the AP 104 and the STAs 106. For example, in some aspects signals can be transmitted and received between the AP 104 and the STAs 106 in accordance with OFDMA techniques. In accordance with these aspects, the wireless communication system 100 can be referred to as an OFDMA system.

A communication link that facilitates transmission from the AP 104 to one or more of the STAs 106 can be referred to as a downlink (DL) 108, and a communication link that facilitates transmission from one or more of the STAs 106 to the AP 104 can be referred to as an uplink (UL) 110. Alternatively, a downlink 108 can be referred to as a forward link or a forward channel, and an uplink 110 can be referred to as a reverse link or a reverse channel.

The AP 104 can provide wireless communication coverage in a basic service area (BSA) 102. The AP 104 along with the associated STAs 106 that utilize the AP 104 for communication can be referred to as a basic service set (BSS). Associated STAs 106 may refer to one or more associated station (e.g., STA 106a) that has performed an association procedure with the AP 104. It should be noted that the wireless communication system 100 may not have a central AP 104, and may alternatively function as a peer-to-peer network between/among the STAs 106. Accordingly, the functions of the AP 104 described herein can additionally or alternatively be performed by one or more of the STAs 106.

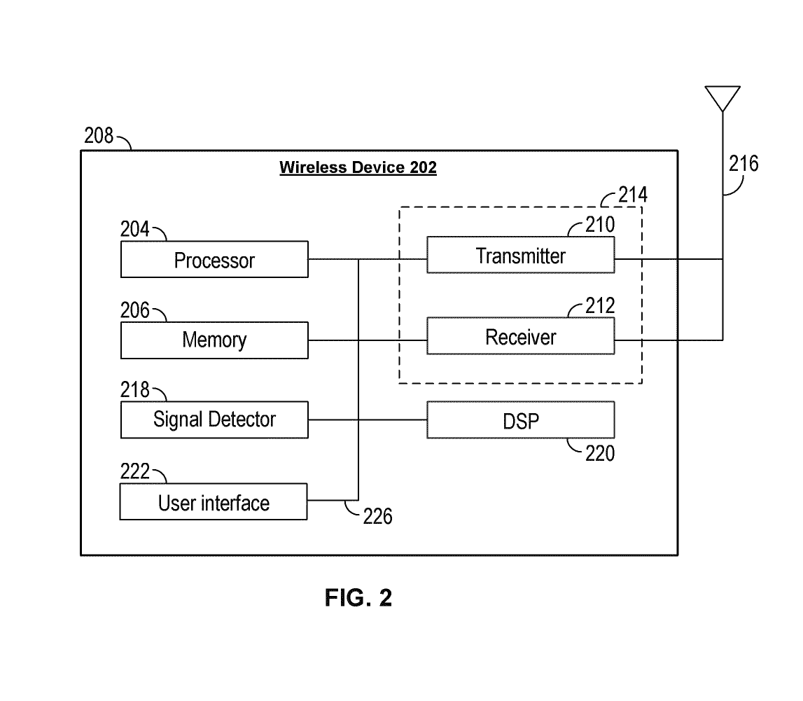

FIG. 2 illustrates various components that can be utilized in a wireless device 202 that can be employed within the wireless communication system 100 of FIG. 1, in accordance with an embodiment. The wireless device 202 is an example of a device that can be configured to implement the various methods described herein. In some aspects, the wireless device 202 can comprise the AP 104 or one of the STAs 106.

As illustrated, the wireless device 202 can include a processor 204, which may be configured to control the operation of the wireless device 202. The processor 204 can also be referred to as a central processing unit (CPU). As illustrated, the wireless device 202 can also include a memory 206, which can include one or both of read-only memory (ROM) and random access memory (RAM). In some aspects, the memory 206 stores or provides instructions or data that may be utilized by the processor 204. In one aspect, a portion of the memory 206 can also include non-volatile random access memory (NVRAM). The processor 204 can be configured to perform logical and arithmetic operations based on program instructions stored within the memory 206. In various embodiments, the instructions in the memory 206 can be executable (e.g., software) to implement the methods described herein.

In various aspects, the processor 204 can comprise, or be a component of, a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). In various embodiments, the instructions, when executed by the one or more processors, cause the processing system to perform the various functions described herein.

The wireless device 202 can also include a housing 208, which can include a transmitter 210 and a receiver 212 to allow transmission and reception of data between the wireless device 202 and a remote location. In some aspects, the transmitter 210 and the receiver 212 can be combined into a transceiver 214. In various aspects, an antenna 216 can be attached to the housing 208 and electrically coupled to the transceiver 214. The wireless device 202 can also include (not shown) multiple transmitters, multiple receivers, multiple transceivers, and/or multiple antennas, which can be utilized during MIMO communications, for example.

As illustrated, the wireless device 202 can also include a signal detector 218 that can be used to detect and quantify the level of signals received by the transceiver 214. In some aspects, the signal detector 218 can detect the received signals as total energy, energy per subcarrier per symbol, power spectral density and other signals. As illustrated, the wireless device 202 can also include a digital signal processor (DSP) 220 for use in processing signals. In various aspects, the DSP 220 can be configured to generate a data unit for transmission. In some aspects, the generated data unit can comprise a physical layer data unit (PPDU), which may also be referred to as a “packet,” a “message” or a “frame.”

As illustrated, the wireless device 202 can further comprise a user interface 222. In some aspects, the user interface 222 can comprise a keypad, a microphone, a speaker, or a display. In accordance with various embodiments, the user interface 222 can include any element or component that conveys information to a user of the wireless device 202 or receives input from the user.

As illustrated, the various components of the wireless device 202 can be coupled together by a system bus 226. The system bus 226 can include a data bus, for example, as well as a power bus, a control signal bus, or a status signal bus in addition to the data bus. In various aspects, the components of the wireless device 202 can be coupled together, or accept or provide inputs to each, other using some other mechanism.

Although a number of separate components are illustrated in FIG. 2, one or more of the components can be combined or commonly implemented. For example, the processor 204 can be used to implement not only the functionality described above with respect to the processor 204, but also to implement the functionality described above with respect to the signal detector 218 or the DSP 220. Further, each of the components illustrated in FIG. 2 can be implemented using a plurality of separate elements.

As discussed above, the wireless device 202 can comprise an AP 104 or an

STA 106, and can be used to transmit and/or receive data. In some aspects, the data units exchanged between the AP 104 and the STAs 106 can include data frames, control frames, and/or management frames. Data frames can be used for transmitting data from an AP 104 or a STA 106 to other APs 104 or STAs 106. Control frames can be used together with data frames for performing various operations or for reliably delivering data (e.g., acknowledging receipt of data, polling of APs, area-clearing operations, channel acquisition, carrier-sensing maintenance functions, etc.). In some aspects, management frames can be used for various supervisory functions (e.g., for joining and departing from wireless networks, etc.).

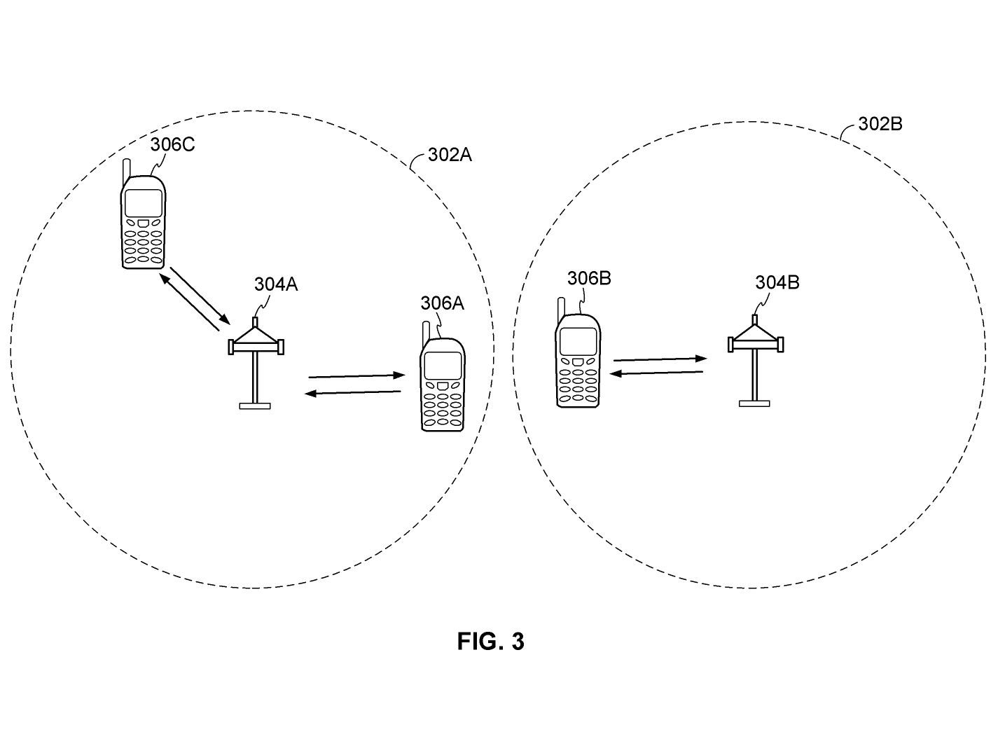

FIG. 3 is an exemplary illustration of two access points and the associated devices in each respective BSS, in accordance with an embodiment. As noted above, the BSS may refer to an AP 104 along with the associated STAs 106 that utilize the AP 104 for communication. For example, as illustrated, the AP 304A may have a BSS 302A, which comprises associated STAs 306A and 306C. In some aspects, the phrase “BSS” may refer to the area which the AP 304A services. Although illustrated here as a circle, this coverage of the BSS 302A is merely illustrative.

The AP 304A may be associated with any number of different STAs. For example, the AP 304A may be associated with more or less than the two illustrated STAs 306A, 306C. Within some geographical proximity to the AP 304A, there may also be other APs, such as AP 304B. The AP 304B may have a BSS, such as BSS 302B, which may comprise one or more STAs, such as STA 306B. Although the BSS of the AP 304A and the AP 304B are not illustrated as overlapping, in some aspects, the BSS 302A from one AP 304A may overlap with the BSS 302B from another AP 304B, or the BSA (not illustrated) of one AP 304A may overlap with the BSA of another AP 304B. In dense deployments, there may be a large number of overlapping BSSes from various APs (also referred to herein as a plurality of wireless communication networks). Each of the BSSes may be based on the same protocols, such as a particular IEEE 802.11 protocol, or may be based on different protocols. Similarly, these BSSes may use the same portion of the spectrum, such as using the same channel (e.g., overlapping or partially overlapping), or may use adjacent or different channels. In some aspects, a channel may comprise a bandwidth, and the bandwidth may be regarded as comprising more than one sub-band (e.g., 5 MHz, 10 MHz, 20 MHz, 40 MHz, 80 MHz, etc.). In accordance with these aspects, OBSSes may be regarded as utilizing overlapping or partially overlapping bandwidths or sub-bands of a channel, or adjacent or different sub-bands of a channel.

In some aspects, deferral rules may be used by devices within a BSS to determine when to defer to other traffic on the wireless medium, when to transmit on the wireless medium, how long to wait before attempting to access the wireless medium, etc. In some aspects, a BSS may achieve better performance if the devices in that BSS have an easier time accessing the wireless medium, such as, for example, when the deferral rules for the BSS have been loosened or made less stringent.

Loosening deferral rules may take multiple forms. For example, in some aspects, clear channel assessment thresholds may be increased. In accordance with these aspects, before a device, such as a STA 106 or an AP 104, transmits on the wireless medium, that device may perform a clear channel assessment (CCA). This CCA may include, for example, determining an average amount of energy that is present on a particular portion of the channel during a particular time or time frame. The device may compare the detected amount of energy to a threshold, in order to determine whether or not the wireless medium is in use. For example, if there is a large amount of energy in the spectrum at a particular time, the device may determine that this portion of the spectrum is in use, and may choose not to transmit on this portion of the spectrum at that time. Accordingly, this threshold may be altered, in order to allow devices to transmit even when larger amounts of energy are present on the wireless medium, or to forbid devices from transmitting when lower amounts of energy are present. Accordingly, adjusting this threshold, depending upon the direction of the adjustment, may be referred to herein as “loosening” or “tightening” the deferral rules for a BSS, as it may make devices either more or less likely to defer to the traffic present on the wireless medium.

In another aspect, deferral rules for a BSS may be loosened to allow devices to transmit on top of packets which they detect when those packets are from an overlapping basic service set (OBSS). For example, from the point of view of a device in the BSS 302A such as STA 306A, the BSS 302B may be thought of as an OBSS. Specifically, for example, STA 306A may be close enough to STA 306B or AP 304B that each of the two devices may be able to receive communications from the other (e.g., when BSS 302A and BSS 302B are using one or more of the same channels and technologies). However, a BSS may adjust its rules, in accordance with one aspect, such that when the STA 306A detects a transmission, and detects that this transmission is from the STA 306B, the AP 304B, or another device in the OBSS (e.g., BSS 302B), the STA 306A may still use the wireless medium, as long as a detected energy is below a certain threshold. Accordingly, making the adjustment above to allow the STA 306A to use the medium more often despite other medium use may also be referred to herein as loosening a deferral rule. In some aspects, loosening of deferral rules may be done for an entire BSS. For example, the AP 304A may transmit a message to each device within the BSS 302A, informing those devices of the deferral rules for the BSS 302A. In some aspects, the AP 304A may additionally or alternatively broadcast a message in the beacon frame, or using a management frame. In some aspects, the loosening of the deferral rules may only apply to certain devices, for example if those devices have a BSS distance that is above a threshold.

In some aspects, a BSS may achieve better performance with less stringent deferral rules when, for example, there are fewer nearby OBSSes. For example, deferral rules may be loosened when there are no “contiguous” BSSes on the same channel. For example, if a BSS is far enough away from neighboring (e.g., within a specified geographical distance) OBSSes on the same channel, deferral rules may be loosened. Similarly, there may be situations in which a BSS may achieve better performance with more stringent deferral rules. For example, when a large number of BSSes overlap, use the same channel, and carry a large amount of traffic, it may be beneficial to use more stringent (e.g., “tightened”) deferral rules in order to reduce packet collisions which may render packets unreceivable. For example, tightening deferral rules may include decreasing one or more CCA thresholds (also referred to herein as a clear channel assessment threshold). In some aspects, an AP may be configured to switch to a primary channel that is not aligned with most of its neighbors when it determines that neighboring BSSes are using the same, or overlapping, channels. Although this switching process may not be considered a deferral rule, it may be useful in lieu of, or in addition to, making deferral rules more or less stringent. Accordingly, methods and apparatus for enabling a BSS to adjust the stringency of its deferral rules or switching channels based on the proximity of OBSSes or how active or inactive the OBSSes are described. In some aspects, there may be one or more neighboring OBSSes, which may also be referred to herein as a plurality of neighboring wireless communication networks.

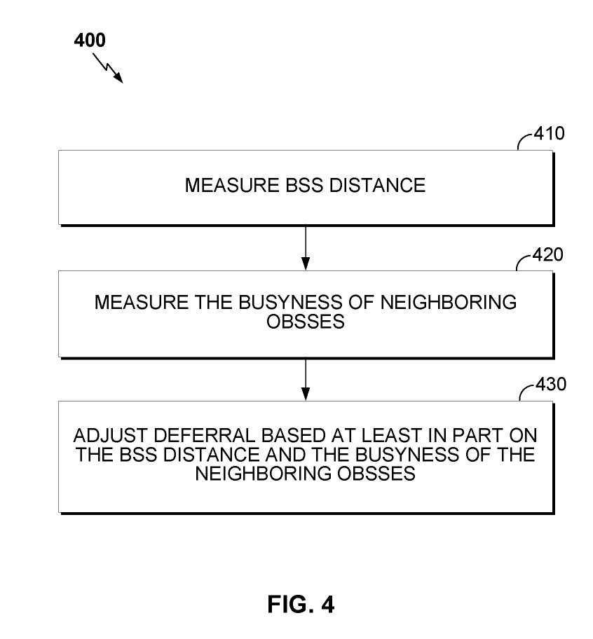

FIG. 4 is an illustration of a method 400 of adjusting deferral rules of a BSS based on BSS distance, in accordance with an embodiment. This method 400 may be used by, for example, an AP such as one of the APs 104, 304A, or 304B. In some aspects, AP 304A, for example, may be configured to transmit deferral rules to the devices within the BSS (e.g., STAs 306A and 306C), and those device may be configured to use the deferral rules which they receive from the AP 304A. In some aspects, method 400 may be used by a STA, such as one of the STAs 106A-D or 306A-C. In some aspects, STA 306A, for example, may be configured to measure one or more BSS distance and adjust its own deferral rules based on the measurements.

Method 400 may start at block 410, where the AP 304A, for example, may measure a BSS distance. This distance may be some metric, such as a number or a ratio, which conveys information about the relative distance of the STAs in a first BSS, such as BSS 302A, as compared to the distance to nearby or “neighboring” BSSes, such as BSS 302B, which operate on one or more of the same channels as the first BSS. For example, this distance may be a ratio which conveys information about the relative distance of STA 306A and STA 306C, compared to the distance from a first access point to a second access point (e.g., from AP 304A to AP 304B, which may be referred to herein as a second distance). In some aspects, the means for measuring a BSS distance may include a processor or a memory, such as the processor 204, the DSP 220, or the memory 206 of FIG. 2.

There may be several possible ways of calculating the “distance” between two

BSSes (also referred to herein as “BSS distance”), in order to determine the proximity of OBSSes. The simplest method of doing this may be to simply measure the distance between two APs, such as the APs 304A and 304B for example. However, this measurement may be insufficient. As illustrated in FIG. 3, the APs 304A and 304B may be some distance from each other, however, their BSSes may still be contiguous because of how close STA 306A and STA 306B are to one another. Due to the proximity of STA 306A and STA 306B, transmissions to or from one of these devices (e.g., STA 306A) may be interrupted by transmission to or from the other device (e.g., STA 306B). In some aspects, this proximity may be overlooked if a BSS distance is measured solely by determining a distance between two APs. Accordingly, it may be desirable to have more nuanced and sophisticated measures of BSS distance. Accordingly, more sophisticated BSS distance measurement methods and apparatus may provide additional information about how far apart the STAs in one BSS are from the STAs in another BSS.

For example, BSS distance may be determined in a number of ways. It will be appreciated that each of these described options may be “mixed and matched” to some extent. For example, certain measures may use averages, or may use values specific to a STA that is the furthest away from its associated AP. In some aspects, each of the described options may use received signal strength indication (RSSI) measurements instead of distance measurements. In accordance with these aspects, the described formulas may need to be adjusted when RSSI is used instead of distance. Any of the measurement options described herein may be used interchangeably by changing the metric in a suitable manner.

A first option for calculating a BSS distance may be calculating the distance from the AP in a BSS to the nearest OBSS AP that operates on the same channel, divided by the distance from the AP in the BSS to the furthest STA in the BSS. For example, in FIG. 3, the APs 304A and 304B may be 100 meters apart from one another, and the STA 306A of BSS 302A may be the furthest STA from the AP 304A at a distance of 40 meters from the AP 304A. Accordingly, in one aspect the BSS distance measurement may be 100 meters divided by 40 meters, or 2.5.

Another option for calculating a BSS distance may be to take an average (or expected value), for each STA in a BSS, of the distance from that STA to the nearest neighboring OBSS AP, divided by the distance from the STA to the AP of its own BSS. For example, in FIG. 3, STA 306A may be 60 meters from AP 304B, which may be the nearest neighboring OBSS AP to STA 306A. STA 306A may also be 40 meters from AP 304A, which is the AP that STA 306A is associated with. Accordingly, the BSS distance, as calculated for STA 306A, may be 60 meters divided by 40 meters, or 1.5. This ratio may be calculated for each AP in BSS 302A, and the ratios may then be averaged to calculate a BSS distance for BSS 302A.

Another option for calculating a BSS distance may be to take the distance between station “x” and its nearest neighboring OBSS AP, divided by the distance from station “x” to the BSS AP that it is associated with, where station “x” is the STA in the BSS which is furthest from the AP. For example, in FIG. 3, STA 306A may be the station in BSS 302A which is furthest from AP 304A. As before, STA 306A may be 60 meters from the nearest OBSS AP, which may be AP 304B, and STA 306A may be 40 meters from the AP in its BSS, which is AP 304A. Thus, this ratio may be calculated by dividing 60 meters by 40 meters, which is 1.5. In some aspects, this formula may be altered by, for example, calculating this ratio for some number of STAs in the BSS. For example, this may be calculated based upon the furthest 1, 2, 4, 5, or some other number of STAs. This ratio may also be calculated for each STA, and the lowest ratio in the BSS may be used, or an average of the lowest 2, 3, 4, 5 or some other number of BSSes.

Another method of calculating BSS distance may be based, at least in part, on the

BSS distance to a particular OBSS. To get a final BSS distance, these OBSS distances can be averaged, or the minimum value can be taken. As another example, the BSS distance of BSS 302A may be based on the distance between an AP 304A and its nearest neighboring OBSS AP in the same channel, such as AP 304B. For example, a BSS distance may be calculated based on the distance from an AP to its nearest neighboring same-channel OBSS AP, divided by the mean distance between the AP and all STAs in that AP's BSS. For example, AP 304A may be 100 meters from AP 304B. STA 306A and 306C may be 40 and 20 meters from AP 304A, respectively. If these two STAs are the only STAs in BSS 302A, the mean distance between AP 304A and STAs in BSS 302A may be 30 meters. Thus, this BSS distance may be determined to be 100 meters divided by 30 meters, or 3.33. In some aspects, the denominator of this BSS distance calculation, instead of the mean distance between the AP and all STAs, may be, for example, the distance to the furthest-away STA in the BSS, the median distance between the AP and a STA in the BSS, or another metric. In some aspects, a number of different BSS distances may be calculated in this manner, for each of a number of different neighboring access points. As discussed, a “final” BSS distance may be determined by averaging these BSS distances for each OBSS, or the minimum BSS distance value may be used.

In some aspects, the distance between an AP and a STA, or an AP and another AP, may be determined or approximated using RSSI values. RSSI may be a measurement of the power present in a received radio signal, and, in some aspects, a distance between two wireless devices may be inferred based upon this metric. For example, a received signal strength may be compared to a transmitter signal strength of that device (which may be known), in order to estimate a distance to a device based on the RSSI. This comparison may be performed by the AP 304A, for example. Further, the RSSI value itself may be used directly in the above calculations, provided that the calculations are modified in order to accommodate the use of an RSSI value. For example, the first option for calculating distance may be modified to use an RSSI value by calculating BSS distance as the RSSI (from the AP in the BSS) to the farthest STA in the BSS, divided by the RSSI (from the AP in the BSS) to the nearest OBSS AP on the same channel. When using an RSSI value rather than a distance, it may be advantageous to switch the numerator and the denominator from the distance-based ratios above. This may be true because an RSSI may be inversely-related to a distance between two wireless devices (e.g., the further a STA is from an associated AP, the lower the receiver strength). Accordingly, it may be beneficial to switch the numerator and denominator when using RSSI values rather than distances. In some aspects, a linear value of RSSI may be assumed.

Method 400 may proceed to block 420, where the AP 304A, for example, may optionally measure the busyness of one or more neighboring OBSSes which share at least a portion of the wireless medium with the BSS 302A of the AP 304A. A busyness metric may be a metric of the wireless medium use at a location of one or more wireless communication devices. The busyness may be based on wireless medium use other than the use of the wireless medium caused by the BSS 302A itself. This wireless medium use may be measured in a channel load element, such as those defined in the IEEE 802.11k standard. A busyness may also be measured in other ways, such as a proportion of time that the wireless medium is in use, which may comprise a proportion of time that an average energy level of the wireless medium is above a specified level.

In some aspects, neighboring OBSSes may share a channel with the BSS 302A, and may use the wireless medium that BSS 302A is using. In some aspects, the means for measuring a busyness of a neighboring OBSS may include a processor or a memory, such as the processor 204, the DSP 220, or the memory 206 of FIG. 2.

One way to measure the busyness of a neighboring OBSS may include using the channel load element which is provided for in IEEE 802.11k. For example, this channel load element may provide information about how busy the wireless medium is at a location of a particular device. For example, AP 304A may request a channel load element from STAs 306A, 306C which are associated with AP 304A. In some aspects, the AP 304A may be configured to request the channel load element measurement from the STAs after using a Restricted Access Window (RAW) or quiet element to silence devices in BSS 302A. Other methods of quieting the medium may also be used. For example, the AP 304A may transmit a clear to send message to itself or may transmit a quiet message, in order to quiet the wireless medium. This may be beneficial as it may allow the BSS 302A to be quiet during the time in which information for the channel load element is gathered. Accordingly, the wireless medium use information in the channel load element from STA 306A may reflect wireless medium use only by OBSSes, rather than by the BSS 302A itself. Thus, traffic from other networks may be isolated from traffic from the network of the AP 304A in this way, and the busyness of other adjacent networks may be determined. A number of different definitions of busyness may be used, including the average channel load across all STAs in BSS 302A, the worst channel load across all STAs in BSS 302A, or the median channel load across all STAs in BSS 302A. In some aspects, the means for determining at least one of these metrics may include a processor or a memory, such as the processor 204, the DSP 220, or the memory 206 of FIG. 2.

Method 400 may proceed to block 430, where the AP 304A, for example, may adjust deferral for BSS 302A, for example, based at least in part on the BSS distance and the busyness of the neighboring OBSSes. In some aspects, this adjustment may be made based on the BSS distance, and a determination of the busyness of a neighboring OBSS may not be made at all. In some aspects, the adjustment of the deferral rules may include adjusting clear channel assessment levels and/or changing the BSS 302A to another channel. In some aspects, these adjustments may be made by transmitting one or more messages from the AP 304A to devices in the BSS 302A (e.g., the STAs 306A and 306C), the message instructing the device of altered clear channel assessment levels, altered deferral rules for OBSS packets, network channels, or other information.

A number of different criteria may be used for loosening deferral rules. For example, certain criteria may be based only on distances between the BSS 302A and neighboring OBSSes. For example, deferral requirements may be loosened if BSS distance is larger than a threshold value. This threshold may be pre-programmed, or may be determined based on observed performance in a wireless communication network. In another option, deferral rules may be loosened if the BSS distance for each station in the BSS is larger than a threshold value. For example, a BSS distance may be calculated for each station in a BSS, and if this value is larger than a threshold for each station, the deferral rules may be loosened. In other aspects, if the BSS distance for each station except one is larger than a threshold, and the BSS distance for the one remaining station is still greater than a second (smaller) threshold, deferral rules may be loosened. The options describe herein are merely exemplary, and there may be other options for loosening or tightening deferral rules based on BSS distance, as well.

In some aspects, deferral rules for a BSS may also be loosened based on a combination of BSS distance and busyness of the wireless medium. For example, these rules may compare BSS distance to a first threshold, and may also compare busyness to a second threshold. If BSS distance is larger than the first threshold and if busyness is less than a second threshold, deferral rules for the BSS may be loosened. Note that when using multiple criteria, it may be possible to use a lower BSS distance threshold than when using BSS distance alone, while still maintaining robust performance. Another criteria for loosening deferral rules may include comparing BSS distance for each station to a threshold value for all stations in the BSS, as well as determining whether busyness is less than a busyness threshold. Alternatively, similar to above, if the BSS distance for each station except one is larger than a threshold, and the BSS distance for the one remaining station is still greater than a second (smaller) threshold, and if is less than a busyness threshold, deferral rules may be loosened. In some aspects, whenever deferral rules are loosened, this may be accompanied by turning on a Request to Send (RTS) and Clear to Send (CTS) system. Such a system may reduce collisions due to, for example, hidden node problems.

Certain conditions may also be established for when deferral rules may be tightened. For example, these conditions may be based solely on BSS distance, or may be based on a combination of BSS distance and busyness. In some aspects, these rules may work in a manner similar to the loosening rules, but may optionally use different threshold values. In one aspect, deferral rules can be tightened if BSS distance is less than a threshold, or if BSS distance for all stations is less than a threshold value. In some aspects, if BSS distance is less than a threshold for at least a given number of OBSSes, deferral rules may be tightened. Other criteria may also be used, similar to the above criteria for loosening deferral rules.

In some aspects, the criteria may also be based on a combination of BSS distance and busyness. For example, if BSS distance is less than a threshold, and if busyness is greater than a busyness threshold, deferral rules may be tightened. Note that the thresholds used here may be different than the thresholds used when busyness is not considered. Adding a busyness threshold may allow the use of a smaller BSS distance threshold. Another option may be to tighten deferral rules if BSS distance for a given station is less than a threshold for at least some number of OBSSes, and if busyness is larger than a busyness threshold.

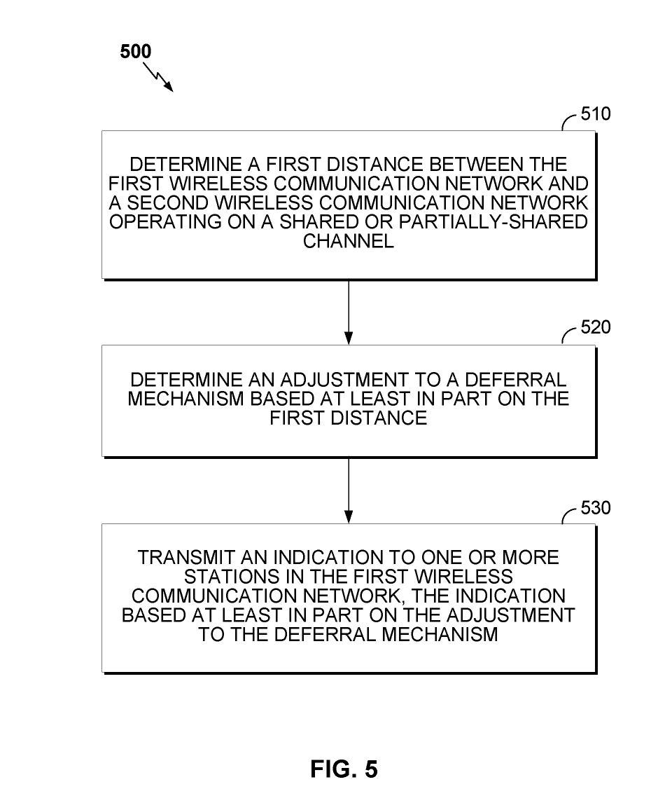

FIG. 5 is an exemplary method 500 of communicating in a first wireless communication network, in accordance with an embodiment. In some aspects, this method may be performed by an access point, such as one of the APs 104, 304A, or 304B in order to either tighten or loosen deferral mechanisms on a given wireless communication network, based on BSS distance. In some aspects, deferral mechanisms may also be based on busyness in addition to BSS distance, as described herein. In some aspects, a method similar to method 500 may be performed by a STA, such as one or more of the STAs 106A-D or 306A-C.

Method 500 may start at block 510, where the AP 304A, for example, determines a first distance between the first wireless communication network and a second wireless communication network operating on a shared or partially-shared channel. In some aspects, the means for determining a distance may include a processor or a memory, such as the processor 204, the DSP 220, or the memory 206 of FIG. 2. In various embodiments, this distance may be determined in a manner similar to the determinations described above with respect to FIG. 4. In some aspects, determining the first distance may include determining a ratio of a distance from an access point to a neighboring access point (e.g., the nearest one) divided by a distance between the access point to a furthest station associated with the access point. In various aspects, determining the first distance may comprise dividing a second distance by a third distance, the second distance based on a proximity of a first access point in the first wireless communication network to a second access point in the second wireless communication network, and the third distance based on a proximity of the first access point to a furthest station associated with the first access point.

In some aspects, determining the first distance may include taking an average of a ratio of a distance from a station associated with an access point to a nearest neighboring access point divided by a distance from the access point to the station, for each station associated with the access point. In various aspects, determining the first distance may comprise determining an average of a second distance divided by a third distance, the second distance based on a proximity of each of the one or more stations associated with a first access point in the first wireless communication network to a second access point in the second wireless communication network, and the third distance based on a proximity of the first access point to each of the one or more stations.

In some aspects, determining the first distance may include determining a ratio of a distance from a station associated with an access point to a nearest neighboring access point divided by a distance from the station to the access point, wherein the station is the station that is furthest away from the access point of all stations associated with the access point. In various aspects, determining the first distance comprises dividing a second distance by a third distance, wherein the second distance is based on a proximity of a station of the one or more stations that is furthest away from a first access point in the first wireless communication network to a second access point in the second wireless communication network, and wherein the third distance is based on a proximity of the station to the first access point.

In some aspects, determining the first distance may include determining a second distance for each neighboring access point, the distance comprising a ratio of a distance from the access point to the neighboring access point divided by a mean distance between the access point and stations associated with the access point. In various aspects, the method 500 may further comprise determining a second distance between the first wireless communication network and each of a plurality of neighboring wireless communication networks operating on the shared or partially-shared channel, wherein determining the second distance comprises dividing a third distance by a fourth distance for each of the plurality of neighboring wireless communication networks, wherein the third distance is based on a proximity of a first access point in the first wireless communication network to a second access point in one of the plurality of neighboring wireless communication networks, wherein the fourth distance is based on a mean proximity of the first access point to each of the one or more stations, and wherein the plurality of neighboring wireless communication networks comprises the second wireless communication network Each of the above-described determinations may utilize received signal strength indications (RSSI) to determine the distance. For example, the BSS distance may be determined either by using the RSSI values to determine the distance directly, or by simply using the RSSI values to determine a BSS distance ratio, as described above.

Optionally, as part of method 500, the AP 304A, for example, determines a busyness of a wireless communication medium. In some aspects, the means for determining a busyness may include a processor or a memory, such as the processor 204, the DSP 220, or the memory 206 of FIG. 2. Determining the busyness may use IEEE 802.11k channel load elements for one or more of the stations associated with AP 304A. In some aspects, determining the busyness may include determining an average channel load across each station associated with an access point in the first wireless communication network, determining a median channel load across each station associated with an access point in the first wireless communication network, or determining a worst channel load across a station associated with an access point in the wireless communication network.

Method 500 may then proceed to block 520, where the AP 304A, for example, determines an adjustment to a deferral mechanism based at least in part on the distance between the first wireless communication network and the second wireless communication network. In some aspects, the means for determining an adjustment may include a processor or a memory, such as the processor 204, the DSP 220, or the memory 206 of FIG. 2. In some aspects, determining an adjustment to a deferral mechanism based at least in part on the determined distance may include comparing the determined distance to a threshold to determine if the distance is greater than, equal to, or less than the threshold. The adjustment that is determined may include at least one of turning request to send (RTS) and clear to send (CTS) messaging on or off within the first wireless communication network, adjusting a clear channel assessment (CCA) threshold upward or downward, modifying deferral rules so that overlapping basic service set (OBSS) traffic with less than a specific energy threshold may be ignored, or changing a primary channel of the first wireless communication network.

In some aspects, method 500 may also include determining a busyness of the first wireless communication network (or of a wireless communication medium utilized by the first wireless communication network), and determining an adjustment to a deferral mechanism based at least in part on the determined first distance may be further based, at least in part, on the determined busyness. In some aspects, determining the busyness may include determining an average channel load seen from OBSSes across each station associated with an access point in the first wireless communication network. In some aspects, determining the busyness may include determining a median channel load seen from OBSSes across each station associated with an access point in the first wireless communication network. In some aspects, determining the busyness may include determining a worst channel load seen from OBSSes across stations associated with an access point in the first wireless communication network. In some aspects, the method 500 may further comprise determining a busyness of the second wireless communication network. In some aspects, the AP 304A, for example, may transmit an indication to the one or more stations to refrain from transmitting messages on the first wireless communication network for a period of time using at least one of a clear to send message, a quiet element, or an indication that the restricted access window will be utilized (e.g., one or more of the STAs 306A-C). Thereafter, the busyness of the second wireless communication medium may be determined based on information obtained during the period of time when the one or more stations are refraining from transmitting.

In various aspects, determining an adjustment to a deferral mechanism based, at least in part, on the determined distance and on the determined busyness may include comparing the determined busyness to a busyness threshold. In some aspects, determining an adjustment to a deferral mechanism based, at least in part, on the determined distance and on the determined busyness may include both comparing the determined distance to a distance threshold and comparing the determined busyness to a busyness threshold. For example, in one aspect, if the determined distance between two BSSes is greater than the specified distance threshold and the determined busyness is below the specified busyness threshold, then the AP 304A, for example, may determine that the deferral rules or mechanisms may be loosened.

Method 500 may next proceed to block 530, where the AP 304A, for example, may transmit an indication to one or more stations in the first wireless communication network, the indication based at least in part on the adjustment to the deferral mechanism. For example, in some aspects, this indication may include a message to devices within the first wireless communication network (e.g., STAs 306A and 306C within BSS 302A) that they should adjust CCA thresholds, in order to make those devices either more likely or less likely to defer to other transmissions. The indication may also include a message to one or more devices in the BSS 302A, for example, that the BSS 302A is moving to another channel. The indication may also turn RTS/CTS on or off within the BSS 302A. In some aspects, the means for transmitting an indication may include a transmitter, such as the transmitter 210 or transceiver 214 of FIG. 2. This indication may be transmitted, for example, in a message which is transmitted periodically, such as a beacon, or in a message that is transmitted during the association of new devices with the BSS 302A. The indication or message may also be sent in broadcast management frames.

In some aspects, STAs 306A and 306C, for example, may further adjust their CCA thresholds based on their unique characteristics, as well as the indication from the AP 304A. For example the STAs 306A and 306C may determine their CCA level as the level given by the AP 304A, adjusted by a value that depends on the STAs 306A and 306C distance to the AP 304A or the level of interference that the STAs 306A and 306C see. Thus, in some aspects, method 500 may comprise transmitting an indication to the one or more stations, instructing the one or more stations to update a clear channel assessment threshold value based, at least in part, on a parameter that is unique that each of the one or more stations.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, the terms “and” or “or” may be interchangeable, and may be interpreted as “and/or” (e.g., anywhere from one to all of the items in a list).

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

The various illustrative logical blocks, modules and circuits described in connection with the present disclosure can be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor can be a microprocessor, but in the alternative, the processor can be any commercially available processor, controller, microcontroller or state machine. A processor can also be implemented as a combination of computing devices, e.g., a combination of a DSP and a microprocessor, a plurality of microprocessors, one or more microprocessors in conjunction with a DSP core, or any other such configuration.

In one or more aspects, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium can comprise non-transitory computer readable medium (e.g., tangible media). In addition, in some aspects computer readable medium can comprise transitory computer readable medium (e.g., a signal). Combinations of the above should also be included within the scope of computer-readable media.

The methods disclosed herein comprise one or more steps or actions for achieving the described method. The method steps and/or actions can be interchanged with one another without departing from the scope of the claims. In other words, unless a specific order of steps or actions is specified, the order and/or use of specific steps and/or actions can be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure can be devised without departing from the basic scope thereof, and the scope thereof is determined by the claims that follow.

What is claimed is:

1. A method of communicating in a first wireless communication network, the method comprising:
determining a first distance between the first wireless communication network and a second wireless communication network operating on a shared or partially-shared channel;
determining an adjustment to a deferral mechanism based at least in part on the first distance; and
transmitting an indication to one or more stations in the first wireless communication network, the indication based at least in part on the adjustment to the deferral mechanism.

2. The method of claim 1, wherein determining the first distance comprises dividing a second distance by a third distance, the second distance based on a proximity of a first access point in the first wireless communication network to a second access point in the second wireless communication network, and the third distance based on a proximity of the first access point to a furthest station associated with the first access point.

3. The method of claim 1, wherein determining the first distance comprises determining an average of a second distance divided by a third distance, the second distance based on a proximity of each of the one or more stations associated with a first access point in the first wireless communication network to a second access point in the second wireless communication network, and the third distance based on a proximity of the first access point to each of the one or more stations.

4. The method of claim 1, wherein determining the first distance comprises dividing a second distance by a third distance, wherein the second distance is based on a proximity of a station of the one or more stations that is furthest away from a first access point in the first wireless communication network to a second access point in the second wireless communication network, and wherein the third distance is based on a proximity of the station to the first access point.

5. The method of claim 1, further comprising:
determining a second distance between the first wireless communication network and each of a plurality of neighboring wireless communication networks operating on the shared or partially-shared channel, wherein determining the second distance comprises dividing a third distance by a fourth distance for each of the plurality of neighboring wireless communication networks, wherein the third distance is based on a proximity of a first access point in the first wireless communication network to a second access point in one of the plurality of neighboring wireless communication networks, wherein the fourth distance is based on a mean proximity of the first access point to each of the one or more stations, and wherein the plurality of neighboring wireless communication networks comprises the second wireless communication network.

6. The method of claim 1, wherein the adjustment to the deferral mechanism comprises at least one of:
turning a request to send and clear to send messaging either on or off;
adjusting a clear channel assessment threshold upward or downward;
changing a deferral mechanism for packets from overlapping basic service sets; and
changing a primary channel of the first wireless communication network.

7. The method of claim 1, further comprising:
determining a busyness of the first wireless communication network, wherein determining the adjustment to the deferral mechanism is further based, at least in part, on the busyness of the wireless communication network.

8. The method of claim 7, wherein determining the busyness comprises determining at least one of:
an average channel load across each of the one or more stations;
a median channel load across each of the one or more stations; and
a worst channel load across each of the one or more stations.

9. The method of claim 7, further comprising:
determining a busyness of the second wireless communication network based on information obtained during a period of time when the one or more stations of the first wireless communication network are not transmitting.

10. An apparatus for communicating in a first wireless communication network, the apparatus comprising:
a processor configured to:
determine a first distance between the first wireless communication network and a second wireless communication network operating on a shared or partially-shared channel; and
determine an adjustment to a deferral mechanism based at least in part on the first distance; and
a transmitter configured to transmit an indication to one or more stations in the first wireless communication network, the indication based at least in part on the adjustment to the deferral mechanism.

11. The apparatus of claim 10, wherein the processor is further configured to determine the first distance based on dividing a second distance by a third distance, the second distance based on a proximity of a first access point in the first wireless communication network to a second access point in the second wireless communication network, and the third distance based on a proximity of the first access point to a furthest station associated with the first access point.

12. The apparatus of claim 10, wherein the processor is further configured to determine the first distance based on determining an average of a second distance divided by a third distance, the second distance based on a proximity of each of the one or more stations associated with a first access point in the first wireless communication network to a second access point in the second wireless communication network, and the third distance based on a proximity of the first access point to each of the one or more stations.

13. The apparatus of claim 10, wherein the processor is further configured to determine the first distance based on dividing a second distance by a third distance, wherein the second distance is based on a proximity of a station of the one or more stations that is furthest away from a first access point in the first wireless communication network to a second access point in the second wireless communication network, and wherein the third distance is based on a proximity of the station to the first access point.

14. The apparatus of claim 10, wherein the processor is further configured to determine a second distance between the first wireless communication network and each of a plurality of neighboring wireless communication networks operating on the shared or partially-shared channel, the second distance determined based on dividing a third distance by a fourth distance for each of the plurality of neighboring wireless communication networks, wherein the third distance is based on a proximity of a first access point in the first wireless communication network to a second access point in one of the plurality of neighboring wireless communication networks, wherein the fourth distance is based on a mean proximity of the first access point to each of the one or more stations, and wherein the plurality of neighboring wireless communication networks comprises the second wireless communication network.

15. The apparatus of claim 10, wherein the adjustment to the deferral mechanism comprises at least one of:
turning a request to send and clear to send messaging on or off;
adjusting a clear channel assessment threshold upward or downward;
changing a deferral mechanism for packets from overlapping basic service sets; and
changing a primary channel of the first wireless communication network.

16. The apparatus of claim 10, wherein the processor is further configured to:
determine a busyness of the first wireless communication network, and determine an adjustment to the deferral mechanism based at least in part on the busyness of the wireless communication network.

17. The apparatus of claim 16, wherein the processor is further configured to determine the busyness based on determining:
an average channel load across each of the one or more stations;
a median channel load across each of the one or more stations; and
a worst channel load across each of the one or more stations.

18. The apparatus of claim 16, wherein the processor is further configured to determine a busyness of the second wireless communication network based on information obtained during a period of time when the one or more stations of the first wireless communication network are not transmitting.

19. An apparatus for communicating in a first wireless communication network, the apparatus comprising:
means for determining a first distance between the first wireless communication network and a second wireless communication network operating on a shared or partially-shared channel;
means for determining an adjustment to a deferral mechanism based at least in part on the first distance; and
means for transmitting an indication to one or more stations in the first wireless communication network, the indication based at least in part on the adjustment to the deferral mechanism.

20. The apparatus of claim 19, wherein the means for determining the first distance comprises means for dividing a second distance by a third distance, the second distance based on a proximity of a first access point in the first wireless communication network to a second access point in the second wireless communication network, and the third distance based on a proximity of the first access point to a furthest station associated with the first access point.

21. The apparatus of claim 19, wherein the means for determining the first distance comprises means for determining an average of a second distance divided by a third distance, the second distance based on a proximity of each of the one or more stations associated with a first access point in the first wireless communication network to a second access point in the second wireless communication network, and the third distance based on a proximity of the first access point to each of the one or more stations.

22. The apparatus of claim 19, wherein the means for determining the first distance comprises means for dividing a second distance by a third distance, wherein the second distance is based on a proximity of a station of the one or more stations that is furthest away from a first access point in the first wireless communication network to a second access point in the second wireless communication network, and wherein the third distance is based on a proximity of the station to the first access point.

23. The apparatus of claim 19, further comprising means for determining a busyness of the first wireless communication network, wherein the means for determining the adjustment to the deferral mechanism comprises means for determining the deferral mechanism based at least in part on the busyness of the wireless communication network.

24. The apparatus of claim 23, wherein means for determining the busyness comprises means for determining at least one of:
an average channel load across each of the one or more stations;
a median channel load across each of the one or more station; and
a worst channel load across each of the one or more stations.

25. A non-transitory computer-readable medium comprising code that, when executed, performs a method of communicating in a first wireless communication network, the method comprising:
determining a first distance between the first wireless communication network and a second wireless communication network operating on a shared or partially-shared channel;
determining an adjustment to a deferral mechanism based at least in part on the first distance; and
transmitting an indication to one or more stations in the first wireless communication network, the indication based at least in part on the adjustment to the deferral mechanism.

26. The non-transitory computer-readable medium of claim 25, wherein determining the first distance comprises dividing a second distance by a third distance, the second distance based on a proximity of a first access point in the first wireless communication network to a second access point in the second wireless communication network, and the third distance based on a proximity of the first access point to a furthest station associated with the first access point.

27. The non-transitory computer-readable medium of claim 25, wherein determining the first distance comprises determining an average of a second distance divided by a third distance, the second distance based on a proximity of each of the one or more stations associated with a first access point in the first wireless communication network to a second access point in the second wireless communication network, and the third distance based on a proximity of the first access point to each of the one or more stations.

28. The non-transitory computer-readable medium of claim 25, wherein determining the first distance comprises dividing a second distance by a third distance, wherein the second distance is based on a proximity of a station of the one or more stations that is furthest away from a first access point in the first wireless communication network to a second access point in the second wireless communication network, and wherein the third distance is based on a proximity of the station to the first access point.

29. The non-transitory computer-readable medium of claim 25, further comprising code that, when executed, determines a busyness of the first wireless communication network, wherein determining the adjustment to the deferral mechanism is further based, at least in part, on the busyness of the wireless communication network.

30. The non-transitory computer-readable medium of claim 29, wherein determining the busyness comprises determining at least one of:
an average channel load across each of the one or more stations;
a median channel load across each of the one or more stations; and
a worst channel load across each of the one or more stations.
